(19) United States
(12) Patent Application Publication
(10) Pub. No.: US 2013/0066787 A1
(43) Pub. Date: Mar. 14, 2013

(54) SYSTEM AND TREATMENT PROCESS OF A FINANCIAL TRANSACTION

(71) Applicant: Jean-Loup DEPINAY, LEVALLOIS PERRET (FR)

(72) Inventor: Jean-Loup DEPINAY, LEVALLOIS PERRET (FR)

(73) Assignee: OBERTHUR TECHNOLOGIES, Levallois-Perret (FR)

(21) Appl. No.: 13/604,145

(22) Filed: Sep. 5, 2012

(30) Foreign Application Priority Data
Sep. 14, 2011 (FR) 1158188

(51) Int. Cl. G06Q 20/40; G06Q 20/34; G06Q 20/22

(52) U.S. Cl. 705/71; 705/39; 705/44; 705/41

(57) ABSTRACT

The invention relates to a system and treatment process of a bank reimbursement transaction of a user of the system having made a first bank expense transaction for a company (30).

The invention relates to a secure and completely dematerialised treatment system for expense claims. It comprises payment means (14) for making a first bank transaction and means for creating the expense claim 15, 16). The system ensures security of the bank data in the treatment process of the expense claim.

The field of the invention relates to a system and a treatment process of a financial document for ordering financial reimbursement transaction, especially an expense claim sent by an employee to his company.

The management of expense claims for companies and employees is problematic. On the one hand for employees it is necessary to keep invoices and proof sops for each expense, to record them on return within the company and to submit them for validation in order to execute the reimbursement transaction. This process can take several days to several weeks. Also, in the case of extended travel and substantial expenses, it can be annoying for the employee to cope with a large expense. This can restrict him from reporting large personal expenses at the same time as business travel.

In response to this problem, delayed payment services are proposed to employees. Payment cards linked to the company can debit the account of the employee with a time lag, allowing payment of the reimbursement before the debit is completed. This solution partially solves the management of expenses for the employee who still remains restricted by the management of paper invoices and data entry. Also, in case of loss or theft of invoices, the employee will find it difficult to have his reimbursement validated, and for the company the latter will not have any means for checking that the requested costs actually do correspond to the expenses really made.

Also, for the company, the management of expense claims creates numerous administrative documents which have to be archived. In the process of creating expense claims, their follow-up and control, some of the documents circulate in paper format, especially invoices, expenditure records and summary sheets. Later on in the process, these documents are generally transformed into digital format for archiving and processing by the administrative services of the company.

Due to the fact that the treatment process is partially physical and partially dematerialised, follow-up on data becomes complex, the possibilities for fraud are as such made easier (backdated expense notes, false expenses, manual control of expenses) and administrative costs are considerable. It is therefore necessary for the company to find an optimised solution for treating expense claims.

Companies fit out employees making regular outside trips with mobile equipment (portable phones or computers) capable of managing invoices electronically very early in the process of managing expense claims. There are mobile applications hosted on portable phones fitted with a photographic sensor for recording an invoice as expense claim, taking a photo of it to record it and transmitting it to the company by a mobile communications network (internet, messages including attachments etc.).

Even if these solutions make management of documents and reduce processing times easier, it is always possible that malware present on the mobile might corrupt the expense claim or an employee tries to deceive the system by sending a false invoice or a backdated invoice.

Also, it is always necessary for the employee to create the expense claim slip for each expense and to record the invoice linked to this expense claim.

Also, according to the management system for company documents, it is necessary for the invoice to be sent to the company accompanied by a formalised and dedicated document for internal company validation.

A first aim of the invention is to secure the process of a bank reimbursement transaction of an expense claim sent by a person.

A second aim of the invention is to reduce management costs of these financial documents.

A third aim is to facilitate and automate administrative processing for example to shorten treatment times for expense claims.

More precisely, the invention relates to a treatment system of a financial document, for example an expense claim, by an establishment associated with execution of a first bank transaction and enabling the execution of a second transaction, said system comprising a mobile user device comprising on-board payment means for ordering the first bank transaction, said bank transaction procuring financial data. According to the invention, the mobile device also comprises means for creating a financial document containing at least said financial data and a communications interface for transmitting the financial document, and the system also comprises a communications interface of the establishment connected to means allowing the establishment to process the financial document for ordering the second bank transaction as a function of said financial data.

Most frequently, the first bank transaction is executed from a first bank account to a second bank account and the second bank transaction is executed from a third bank account to the first bank account.

The second bank transaction is a reimbursement transaction of the user, the first bank account belonging to the user ordering the first bank transaction and the third bank account belonging to the establishment.

According to a variant embodiment, the mobile device and the establishment also comprise cryptography means such that the data exchanged between the communications interfaces of the mobile and of the establishment are secure.

According to a variant embodiment, the cryptography means, the means for creating the financial document of the mobile device and the treatment means of the establishment are arranged such that the financial document is encrypted in the mobile device by means of a first cryptographic key, and is decrypted within the establishment by a second cryptographic key for transmitting the execution order of the second bank transaction from financial data of the financial document.

The cryptographic key is preferably exchanged between the mobile device and the establishment via the communications interfaces of the mobile and of the establishment.

According to a variant embodiment, the cryptographic key is a datum exchanged in an initialisation bank transaction, prior to the first transaction, and made between the communications interfaces.

According to a variant embodiment, the computer treatment means comprise a data server for recording the financial document and a computer program for presenting the financial document recorded on the data server to a validation authority for authorising the second bank transaction.

According to a variant embodiment, the communications interfaces of the mobile device and of the establishment are short-distance communications means, for example of NFC type.

The invention also relates to a mobile device comprising a communications interface and a smart card comprising a memory and a processor for executing instructions, the smart card and the communications interface being configured for executing a first computer program of a payment application for ordering a first bank transaction, said first bank transaction procuring financial data. According to the invention, the mobile device also comprises means for creating a financial document, for example an expense claim, for ordering a second bank transaction as a function of said financial data.

For this purpose, the means for creating the financial document comprise a second computer program for ordering the creation of the financial document and a third computer program for creating the financial document and for recording the financial document in the memory.

According to a variant embodiment, the first and the third computer program are hosted on the smart card.

Also, according to a variant embodiment the second computer program controls the mobile device such that the mobile device is used as interface with the user for ordering the creation of the financial document.

The invention also relates to a treatment process of a financial document by an establishment, for example an expense claim. According to the invention, it comprises the following successive steps:
execution of a first bank transaction by means of a payment application, said bank transaction being executed from a first bank account to a second bank account and procuring financial data,
presentation to the user by means of an interface of the mobile device of an application for creation of a financial document linked to the first bank transaction,
transmission of financial data from the payment application to an application for creation of the financial document hosted on the mobile device,
recording of the financial document from financial data in a memory of the mobile device,
transmission of the financial document to a data server of the establishment accessible by a validation entity authorised to give the execution order of a second bank transaction relative to the first bank transaction,
execution of the second bank transaction from a third bank account to the first bank account after receipt of the execution order of the validation authority of the establishment.

According to a variant of the process, it also comprises a step for execution of an initial bank transaction between the first and the third bank account, prior to the first bank transaction, for generating a cryptography key for securing the data exchanges between the mobile device and the establishment.

The invention has the advantage of being a secure expense claim treatment system and being completely dematerialised. The system according to the invention uses a process in which data are recorded in a secure element and whereof the data can be encrypted by a key exchanged between the secure element (SIM card, MMC (MultiMedia Card)) and the processing establishment of the expense claim.

Also, because of the invention, the processing establishment of the expense claim can easily access the transaction information. It is easy for the establishment to produce data statistics used in the company since the information are recovered at the source of the process, by being automated or entered manually by the user.

The invention will be better understood and other advantages will emerge from the following description given by way of non-limiting example and in reference to the attached figures, in which:

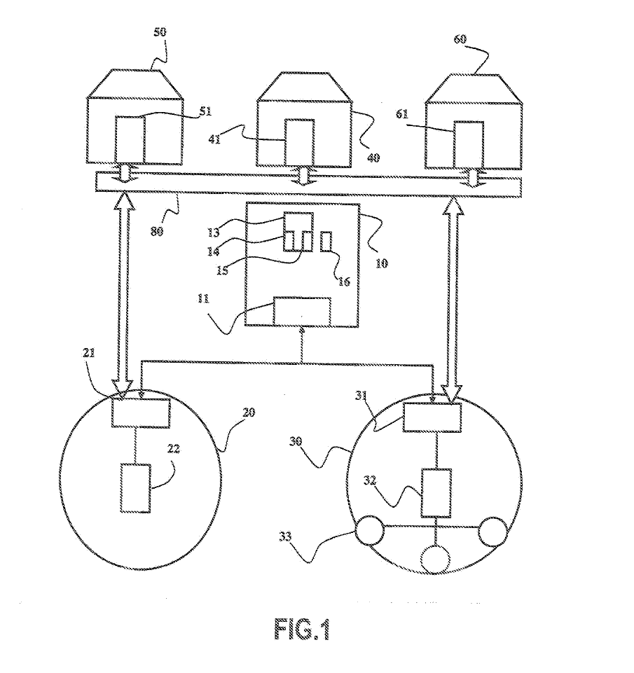

FIG. 1 illustrates a functional diagram of the expense claim treatment system according to the invention.

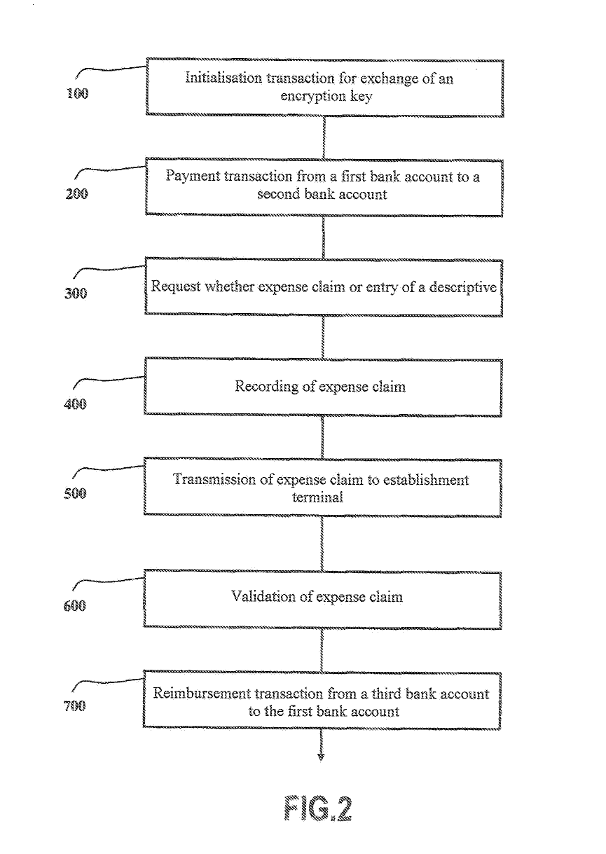

FIG. 2 illustrates a diagram of the treatment process of an expense claim according to the invention.

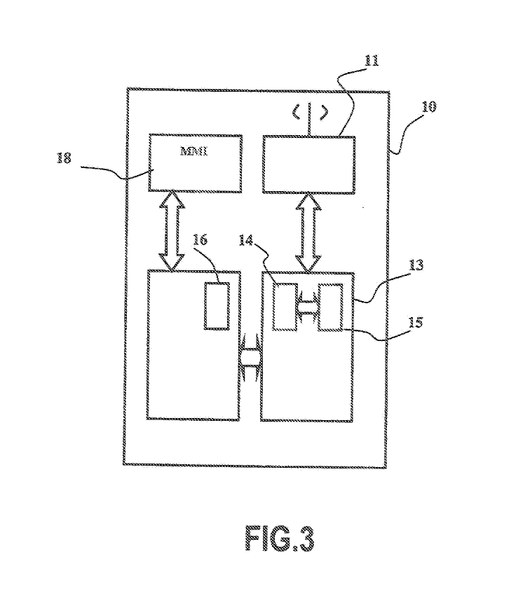

FIG. 3 illustrates a diagram of the mobile device which can execute the invention.

The financial document treatment system according to the invention applies particularly to the management of expense claims, more generally called reimbursement orders, sent by an employee to the establishment where he is employed. The invention proposes a treatment system of the reimbursement process completely dematerialised from execution of the bank payment transaction to the step for execution of the final reimbursement bank transaction.

FIG. 1 proposes a description of functional architecture of an expense claim treatment system sent by an employee having mobile equipment 10 to an establishment 30 of his employer. During a professional appointment, the employee creates an expense linked to his appointment (for example meal expenses, furniture purchase, transport costs etc.). This first bank transaction debits the bank account of the user of the mobile device to credit the bank account of the merchant.

According to the invention, the expense claim treatment system comprises mobile equipment 10 more precisely described by FIG. 3, his portable phone for example, having on-board payment means 14. In particular, the telephone 10 comprises a remote communications interface 11 of NFC type (Near Field Communication) enabling the transmission of bank data for short-range contactless payments, that is, a range of a few centimetres to a few tens of centimetres. An NFC communications interface 11 comprises electronic radiofrequency components including at least one antenna in communication with an electronic device 13 comprising at least one processor and a memory. This electronic device enables storage, treatment and transmission of digital data via the communications antenna. The processor is capable of executing instructions for running on-board computer programs 14 and 15 on the smart card 13.

The device electronic 13 is preferably the smart card, also called SIM card, provided by the operator of the portable phone 10. According to another embodiment, an application using NFC communications can be used by means of a secure card memory of type “SD CARD” (Secure Digital Card). The particular characteristic of these smart card devices 13 is being secure elements allowing data protection by preventing access to a person not authorised by the carrier. These elements comprise cryptography means for securing data and transfer of data between the user and the establishment.

The calculation capacities of the processor of the secure smart card 13 and the memory resources enable execution of software applications, developed by way of example according to the specifications of the GlobalPlatform® standard using Java Card® technology. The GlobalPlatform and standard the Java Card technology software are used specifically for applications hosted on secure elements of SIM card type, commonly known by the acronym UICC (Universal Integrated Circuit Card).

According to the invention, a payment application 14 is hosted on the SIM card of the portable phone 13 as well as an application 15 for creation of an expense claim from bank data transmitted by the application 14. These two applications 14 and 15 are developed according to the specifications defined by the GlobalPlatform standard, and interoperability and data communication between the two applications are consequently overseen by these specifications. The payment application 14 is capable of communicating with an external device dedicated to remote payment by means of the communications interface 11 of NFC type. Communications of secure data transmitted by an interface of NFC type are generally developed according to GlobalPlatform specifications.

Also, the bank data which are transmitted between the payment application 14 and the application for creation of an expense claim 15 present a high level of security because they are transmitted between the two applications by means of internal communications to the secure element 13. So, the process for creation of the expense claim is implemented most closely to the payment process used on the smart card 13.

The vendor 20 for his part has an NFC communications interface communicating with payment means 22 in relation to a bank entity. The payment service communicates the bank transaction information to the bank 40 and the bank 50 which comprise the technical means 41 and 51 for completing the bank transaction. This bank transaction is movement of money from the bank account of the user and to the bank account of the vendor. The bank of the user 40 is in communication with the bank of the vendor 50 and the payment terminal 22 to validate payment, and also hosts the technical means 41 necessary for completing the bank transaction. These technical means 51 and 41 are data servers, information communications networks and software solutions for management of all banking operations. The data servers contain for example the personal data of each client and the lists of services to which they have subscribed (identifying bank account, payment means and payment service via NFC application, mobile payment application). The bank 60 of the employer also hosts the same technical means 61 for management of bank transactions. Banking institutions communicate over a secure communications network 80 for bank data to exchange these data between them and with electronic payment terminals. By way of example, payment terminals, payment means and banks utilise solutions of type EMV (Europay Mastercard Visa) for executing banking transactions and communicate by way of networks dedicated to these transactions.

According to another variant of the invention, payment application can be a payment application via the network Internet. In this case, the application is not hosted on the secure element. The payment application in this configuration can be an application installed on the mobile phone 10.

According to FIG. 1, the bank entity 40 is the establishment of management of bank accounts of the user of the mobile device 10, the bank entity 50 is the establishment of management of bank accounts of the merchant and the bank entity 60 is the establishment of management of bank accounts of the establishment employing the user. These banking establishments are represented by different entities but can also be the same bank entity. For example, it is possible that the banking establishment 40 holding the bank account of the user is the same as that holding the account of the vendor 50.

According to the invention, when a bank transaction is executed and when an invoice including the bank data of the transaction is sent, the latter can be transmitted in electronic format directly to the mobile device 10 of the user. The mobile device 10 then records the invoice electronic in a memory space. This functionality is created by the payment application 14 hosted on the SIM card 13. The bank data of the electronic invoice are recorded on the memory space of the SIM card 13.

Following the transaction, as described in FIG. 3, a software application 16 hosted on the mobile executes the commands needed to query the user via the man-machine interface (MMI) 18 of the mobile device 10 if the invoice sent for the transaction must be recorded as an expense claim. The software application 16 of the mobile device, commonly called “Midlet”, is hosted on the mobile device 10 and is executed by electronic means (processor, memory, communication bus etc.) integrated into the mobile.

According to the embodiment, the Midlet 16 is triggered automatically following a bank transaction; in this case the man-machine interface 18 of the portable device displays, if it is a screen, a dialog box querying the user. According to another embodiment, the Midlet 16 is triggered on request of the user following the transaction at a time selected by the user. According to another embodiment, the triggering of the Midlet 16 and the validation authorisation as expense claim can be validated automatically in a period defined by the user.

This Midlet 16 triggers an exchange of data between the payment application 14 and the application for creation of the expense claim 15. The application for creation of the expense claim 15 creates, from some of the bank data of the payment invoice, an expense claim to which other data are optionally added. For example, these data can be data originating from the Midlet 16 if the latter has asked the user to advise of the context of the transaction (place and type of transaction, reason of the expense for example). This entry is made via the man-machine interface of the mobile device 10. The resulting expense claim contains the financial data of a bank transaction but can also combine financial data from several banking transactions. In this case, during reimbursement, a single bank transaction could be executed to reimburse a plurality of banking transactions by order of this single expense claim.

The bank document of expense claim type contains the bank data for the amount of the bank transaction, the date, the place of the bank transaction, of those parts having to proceed with transaction and also the subject of the transaction. It can also comprise the identity of the person or the bank account of the person within the entity of the establishment concerned by the first bank transaction and which has to reimburse the user.

Also, there is no exchange of critical non-encrypted data via the communications means and the software applications of the mobile device 10. Effectively, according to the invention, the bank data which are the most critical data needing to be protected are not exchanged with the Midlet 16. So, this architecture prevents use of spyware which might corrupt the bank data. According to the invention, the financial data do not leave the smart card 13 during transmission of the payment application 14 to the application for creation of the expense claim 15.

According to the execution environment hosted on the mobile 10, the midlet 16 can utilise JSR 177 Security and Trust Services API for J2ME or the SIM toolkit to communicate with the payment application 14 and creation of the expense claim 15.

Also, according to a preferred mode of the invention, the data of the expense claim created by the application 15 are secure with cryptography means during their transmission between the communications interfaces 11 and 31 to the treatment means of the financial document 32. For example, first cryptography means can be a cryptography mechanism by a cryptographic key, or several cryptographic keys. This can be architecture with symmetrical or asymmetrical keys.

For example, a cryptographic key can be exchanged with the computer system 32 for treatment of the expense claim of the establishment 30 by means of an initialisation bank transaction having a zero sum. The function of this bank initialisation transaction is not to trigger movement of money, this is why the balance is zero, but to allow the exchange of data utilised by the application 15 for creation of the expense claim. These data can be the data of the bank account of the user on which the reimbursement payment must be made and also the cryptography key for encrypting electronic files relative to the expense claim. According to a variant, the cryptographic key is the cryptogram exchanged during a bank transaction of EMV type between the terminal 32 of the company and the mobile device 10. Because of the initial transaction of a zero sum, the bank data of the user are transmitted to the bank for managing the bank accounts of the establishment so that the bank data of the user are kept updated. On completion of this transaction, the bank retains the bank data in its databases.

This terminal of the establishment preferably uses a communications interface 31 of NFC type connected to software means for conducting banking transactions or secure data exchanges. in the case of a bank transaction, the transaction cryptogram is generated by the secure element 13 of the mobile device 10 on which the payment application 14 is hosted.

The sharing mechanism between the applications is based on Global Services interfaces defined by Global Platform. The application for creation of the expense claim 15 is recorded as an expense claim service. This recording is subject to a privilege delivered by the applications manager, therefore the application expense claim has been deemed secure by the manager. Because of this certification, the payment application can therefore deliver this cryptogram in confidence to the application for creation of an expense claim.

Other security mechanisms for data between the mobile device 10 and the establishment 30 are possible. This can be a cryptographic authentication mechanism (MAC for “message authentication code”), signatures and or encryptions. Cryptography techniques are known to the expert and choice is adapted according to the needs of the technical implementation of the invention.

The treatment system of the financial document also comprises an encryption device of a financial document generated by an application 15 hosted on the mobile terminal 10 in which a payment application 14 procures a bank transaction cryptogram which is used as cryptography key for encrypting the financial document. The cryptogram is also with exchanged the establishment which processes the financial document. The sum of the bank transaction is preferably zero, the latter is utilised for exchanging bank data and generating a cryptography key between an establishment and a user of the encryption device.

The applications 14 and 15 of the secure element 13 are applications installed by the service operator of the secure element. In the case of a SIM card, this is generally the telephone communications service operator who administers the SIM card. The Midlet 16 can be installed when proposed by the same service operator or on request of the user via access to an applications server.

In the case of an establishment of company type, the secure element 13, for example an SD card and the communications interface 11 can be the property of the company. in this case, the company itself administers the applications 14, 15 and 16 installed in the mobile device 10.

The application 15 for creation of an expense claim comprises the data software and processing means for encrypting the financial document containing the bank data and optionally other information used for their treatment by the establishment 30. The user, once back from an appointment and after having recorded in his phone the expense claims associated with his appointment, can transmit the encrypted electronic files for expense claim to his establishment by means of the communications interface 31 of NFC type. This communications interface 31 ensures the security of information. This interface is connected to treatment means 32 of electronic files. if the latter are encrypted, these treatment means 32 comprise in memories the decrypting key and the software means for decrypting the files.

In a preferred embodiment, the communications interface 31 is a fixed station in the perimeter of the establishment 30 having communications means NFC provided for communicating with the communications interface 11 of the mobile phone 10 of the user. The communication of data between the mobile phone 10 and fixed the station is secure short-distance communication.

According to other variant embodiments, the communications interface is another type of remote communications interface or a wired communications interface. The type of communication selected between the two interfaces must permit secure exchange of data between the secure element 13 of the mobile device 10 and the expense claim treatment means 32 of the establishment. For example, this interface can be connected to an Internet network to which the establishment is itself connected, a wifi network or a Bluetooth® connection.

The treatment means for expense claim electronic files 32 comprise a contactless and/or wired internal network communications (for example Ethernet, WIFI) for connecting the communications interface 31 and a data server which records the expense claim files, the personal data of the user, and data for treatment of expense claims, for example the department in which he works, the hierarchy which has the authority to validate his expense claim.

Also, in the embodiment where electronic files are encrypted by a key, the treatment means comprise means for recording this key and associating it with the user and means for decrypting electronic files. These decrypting means can be used from software applications hosted at the level of the central data server or hosted at the level of the communications interface 31. If a different cryptography mechanism among those mentioned above is used, the treatment means are adapted to the selected security mechanism of the data.

The expense claim treatment system also comprises software applications for transmitting the electronic files to persons 33 having the authority to validate the reimbursement transaction linked to the expense claim. According to the organisation of the establishment, the expense claims must be accessible by one or more persons. The treatment applications must provide the validation and reimbursement order commands. According to the organisation and the hierarchic level of the person sending the expense claims, the validation and the reimbursement order is automatic.

The software treatment application can be an application dedicated to treatment of expense claims, or for example can be electronic messaging. According to this latter treatment process the electronic file is sent to the person authorised to validate reimbursement then this person retransmits file to the financial department which executes the reimbursement order. In another variant embodiment, once the electronic file is received at the level of the communications interface 31 and decrypted, the latter can be printed and transmitted physically paper in form to these same persons.

Next, once the expense claim is validated, the establishment 30 sends a bank transaction execution order to its banking establishment 60 so that the reimbursement transaction is made for the employee of the establishment 30. This second bank transaction debits the bank account of the establishment sponsoring his appointment and credits the bank account of the user of the mobile device.

Also, according to the data contained in the financial document and the organisation of the financial establishment, the expense claim can comprise bank data from several banking transactions each of which can be validated by a different validation authority. Then, each validation authority can send a bank transaction execution order from its own bank account to the bank account of the user. The software treatment application comprises software functionalities for validation by several authorities and the sending of a bank transaction execution order from one or more bank accounts. If the establishment is a organisation comprises several subentities, then the software treatment application of the financial document networks these different subentities. The financial entities of each entity can be associated or not.

According to a variant of the treatment system, the treatment means 32 and the mobile device 10 can be equipped with computer means for following up on the processing of the expense claim. The information can be transmitted by the communications interfaces 31 and 11 or by other communications means between the mobile device and the treatment means 32. This information can, for example, be the information of the reimbursement action and/or the reimbursement date provided. Also, instead of being followed by dematerialised information between the mobile device and the treatment means 32 of the establishment, this can also be used by information in the form of paper mail.

An embodiment of the treatment process of the expense claim is described by FIG. 2. This process comprises an initial step 100 for execution of a payment transaction of a zero sum between the company and the user of the mobile 10. The aim of this step is to initialise the treatment means 32 of the expense claim and the application 15 for creation of the expense claim. In particular, an encryption/decryption key can be generated and exchanged between the company 30 and the mobile device 10 during the initial step. This key is for example a transaction cryptogram exchanged by the payment application 16 hosted on the secure element 13.

According to the treatment process, in a following step 200 the user makes a payment transaction by means of the payment application 14 hosted on the SIM card of the mobile phone 10. This is preferably a transaction of NFC type with an adapted terminal at the vendor.

In a following step 300, a request is made to the user via the MMI of his mobile phone so that the invoice of the bank transaction is recorded as an expense claim. This request is generated by a Midlet hosted on the mobile phone and is triggered by the payment transaction or manually by the user.

In a step 400, an expense claim is recorded in the memory of the secure element 13. This expense claim can be encrypted by means of the key exchanged during the initial step.

In a step 500, the user presents his mobile phone at a fixed station having communications means NFC belonging to the company. During this step, the electronic files relative to the expense claim are transferred to the treatment means of the expense claim. The files are then decrypted and then recorded on a data server.

According to the selected cryptography mechanism, the functions linked to the securing of data during steps 400 and 500 can be different (signature, authentication, encryption by a first key, decryption by a second key, symmetrical or asymmetrical keys).

In a step 600, the files expense claim are presented to a competent authority for validating and ordering execution of the reimbursement transaction.

Finally, in a step 700, the reimbursement transaction is executed and the bank account of the user, which has made the first bank transaction, is credited with the sum indicated in the expense claim. Most frequently, the second bank reimbursement transaction is executed after the first bank payment transaction, but in the case of a debit transaction the account of the user can be debited by delay of the payment order such that the transaction debit occurs after the reimbursement transaction of the account of the user.

The invention applies to the processing systems for a financial document for ordering a bank reimbursement transaction of the bank account from an establishment or organisation of persons for whom a first bank transaction has been made to the bank account of the executor of the first bank transaction. This relates to expense claims or more generally to reimbursement orders.

1. A system for treatment of a financial document, for example an expense claim, by an establishment associated with execution of a first bank transaction and enabling the execution of a second transaction, said system comprising a mobile device user comprising on-board payment means for ordering the first bank transaction, said bank transaction procuring financial data, characterised in that:
the mobile device also comprises means for creating a financial document containing at least said financial data and a communications interface for transmitting the financial document,
and in that the system also comprises a communications interface of the establishment connected to means allowing the establishment to treat the financial document for ordering the second bank transaction as a function of said financial data.

2. The system as claimed in claim 1, characterised in that the first bank transaction is executed from a first bank account to a second bank account and the second bank transaction is executed from a third bank account to the first bank account.

3. The system as claimed in claim 2, characterised in that the second bank transaction is a reimbursement transaction of the user, the first bank account belonging to the user ordering the first bank transaction and the third bank account belonging to the establishment.

4. The system as claimed in claim 1, characterised in that the mobile device and the establishment also comprise cryptography means such that the data exchanged between the communications interfaces of the mobile and of the establishment are secure.

5. The system as claimed in claim 4, characterised in that the cryptography means, the creation means of the financial document of the mobile device and the treatment means of the establishment are arranged such that the financial document is encrypted in the mobile device by means of a first cryptographic key, and is decrypted within the establishment by a second cryptographic key for transmitting the execution order of the second bank transaction from financial data of the financial document.

6. The system as claimed in claim 5, characterised in that the cryptographic key is exchanged between the mobile device and the establishment by the communications interfaces of the mobile and of the establishment.

7. The system as claimed in claim 5, characterised in that the cryptographic key is a datum exchanged in an initialisation bank transaction, prior to the first transaction, and made between the communications interfaces.

8. The system as claimed in claim 1 characterised in that the computer treatment means comprise a data server for recording the financial document and a computer program for presenting the financial document recorded on the data server to a validation authority for authorising the second bank transaction.

9. The system as claimed in claim 1, characterised in that the communications interfaces of the mobile device and of the establishment are short-distance communications means, for example of NFC type.

10. A mobile device comprising a communications interface and a smart card comprising a memory and a processor for executing instructions, the smart card and the communications interface being configured for executing a first computer program of a payment application for ordering a first bank transaction, said first bank transaction procuring financial data, characterised in that the mobile device also comprises means for creating a financial document, for example an expense claim, for ordering a second bank transaction as a function of said financial data.

11. The device as claimed in claim 10, characterised in that the means for creating the financial document comprise a second computer program for ordering the creation of the financial document and a third computer program for creating the financial document and for recording the financial document in the memory.

12. The device as claimed in claim 10, characterised in that the first and the third computer program are hosted on the smart card.

13. The mobile device as claimed in claim 10, characterised in that the second computer program controls the mobile device such that the mobile device is used as interface with the user for ordering the creation of the financial document.

14. A treatment process for a financial document by an establishment, for example an expense claim, characterised in that it comprises the following successive steps:
Execution of a first bank transaction by means of a payment application, said bank transaction being executed from a first bank account to a second bank account and procuring financial data,
Presentation to the user by means of an interface of the mobile device of an application for creation of a financial document linked to the first bank transaction,
Transmission of financial data from the payment application to a application for creation of the financial document hosted on the mobile device,
Recording of the financial document from financial data in a memory of the mobile device,
Transmission of the financial document to a data server of the establishment accessible by a validation entity authorised to give the execution order of a second bank transaction relative to the first bank transaction,
Execution of the second bank transaction from a third bank account to the first bank account after receipt of the execution order of the validation authority of the establishment.

15. A process as claimed in claim 14, characterised in that it also comprises a step for execution of an initial bank transaction between the first and the third bank account, prior to the first bank transaction, for generating a cryptography key for securing data exchanges between the mobile device and the establishment.
